(19) United States
(12) Patent Application Publication
(10) Pub. No.: US 2002/0145029 A1
(43) Pub. Date: Oct. 10, 2002

(54) Fish tape and driver therefor

(76) Inventors: Bruce P. Konen, Aurora, IL (US); Thomas A. Nelson JR., Naperville, IL (US)

Correspondence Address: COOK, ALEX, McFARRON, MANZO,, CUMMINGS & MEHLER, LTD., 200 West Adams Street -Suite 2850, Chicago, IL, 60606, US

(21) Appl. No.: 09/902,897

(22) Filed: Jul. 12, 2001

Related U.S. Application Data
(62) Division of application No. 09/827,021, filed on Apr. 5, 2001.

(51) Int. Cl. B65H 20/00; G03B 1/56

(52) U.S. Cl. 226/188; 226/90; 226/176; 226/185

(57) ABSTRACT

A fish tape has a galvanized wire core wrapped by a twin-ribbon stainless steel sheath. The fish tape is flexible enough to be convenient to handle and store in a coil while still being stiff enough to fish through a conduit. A driver may be used to push or pull the fish tape. The driver has a housing with drive and pressure rollers therein for engaging the fish tape. The drive and pressure rollers each have curved and flat grooves for engaging a fish tape. The drive roller is driven by first and second right angle gears from a drive shaft which is connectable to the chuck of a hand drill. The drive shaft is arranged to be parallel to the fish tape. The driver housing has a slot for receiving the fish tape by moving the tape perpendicular to the length of the tape. A retainer is movable to open and close the housing slot.

### CROSS-REFERENCE TO RELATED APPLICATION

This application is a divisional of application Serial No. 09//827,021, filed Apr. 5, 2001.

### BACKGROUND OF THE INVENTION

This invention relates to fish tapes, and more particularly, to novel systems and methods for threading electrical wires through installed conduit systems. Fish tapes are elongated members which are pushed through a conduit. Electrical wires are attached to the fish tape and then the fish tape is pulled back through the conduit, carrying the wire or wires with it. Typically a fish tape is formed of a flat, spring steel material. Fish tape lengths range from 25 feet to 200 feet. The tape is usually stored in coiled form in a case or reel. Most commonly the fish tape is reeled out by hand. Orientation is extremely important in reeling a fish tape up onto a spool or reel. Enclosed reels provide no rapid method for deployment or retrieval. Moreover, ergonomic factors have received only minimal attention. Thus, a user typically requires approximately 15 minutes to deploy and use 100 feet of fish tape. After deployment, a user attaches to the end of the fish tape an electrical wire or wires that are to be pulled back through the conduit. Pulling the fish tape back out typically takes additional time and physical effort of pulling, snagging, forcing and wrestling. In the best systems available, the fish tape may be retrieved into a case as it is being drawn back through the conduit, pulling its load. However, a user must often abandon such retrieval into the encased reel in order to pull directly on the tape against the load of friction, snags and other obstructions. One of the reasons is the traditional spring steel fish tape is a highly unruly material in that it always wants to spring out to a straight, elongated condition; it has to be forced into a coil shape on a reel.

Meanwhile, pushing tapes by hand is slow and unsteady. A static coefficient of friction is greater than a dynamic coefficient of friction. Accordingly, keeping a tape moving can considerably ease the number of snags due to friction. There are several devices in the prior art with powered drivers for deploying and/or retrieving fish tape. Examples are shown in U.S. Pat. Nos. 2,729,424; 3,145,972; 3,220,700; 3,258,246; and 5,692,662. Of these U.S. Pat. No. 3,220,700 discloses use of a hand drill to power the device. However, in general the prior art drivers are bulky and relatively clumsy to use and require a separate motor included in the driver.

### SUMMARY OF THE INVENTION

In view of the foregoing, it is a primary object of the present invention to provide a simple, high speed driver for threading wires through conduit. The driver is powered by an ordinary hand drill. The driver has a housing with a main shaft and an idler shaft mounted parallel to one another in the housing. A drive roller is mounted for rotation on the main shaft and a pressure roller is mounted for rotation on the idler shaft. The rollers are aligned with one another to define a throat along the tangents to the rollers that are parallel and closest to one another. The throat has an axis that is perpendicular to the main and idler shafts. The throat is adapted to receive a fish tape therein along the throat axis. The rollers are engageable with a fish tape placed in the throat to drive the fish tape. A drive mechanism includes a first right angle gear in driving engagement with the drive roller. A drive shaft is mounted for rotation in the housing parallel to the throat axis and extending to a proximal end exterior of the housing. The proximal end is engageable with a hand drill. A second right angle gear meshes with the first right angle gear and is mounted for rotation with the drive shaft. This arrangement allows the user to hold the drill and driver with one hand while leaving the other hand free for holding a ladder or the fish tape.

The driver housing has a slot for providing access to the throat. A retainer arm is movable to open or close the slot. The retainer arm can prevent the fish tape from canting in the throat. The pressure roller and drive roller each have two grooves, one designed for engaging a flat fish tape and one for engaging a fish tape having a generally circular cross section. A quick release mechanism is provided to allow fast and easy locking and unlocking of the pressure roller.

The present invention also concerns a new fish tape material. This tape is generally round in cross section. It has an inner wire rope surrounded by an armor wrap around the wire rope. This construction provides lateral stiffness balanced with a selected amount of lateral flexibility. The fish tape supports axial compression and tension when forced through a conduit. The armor wrap comprises two separate ribbons of stainless steel with no gap between adjacent convolutions of the wrap.

### BRIEF DESCRIPTION OF THE DRAWINGS

FIG. 1 is a perspective view of the fish tape driver of the present invention.

FIG. 2 is a top plan view of the fish tape driver.

FIG. 3 is a front elevation view of the fish tape driver.

FIG. 4 is a side elevation view of the fish tape driver.

FIG. 5 is a front elevation view of the fish tape driver, with the front of the housing removed to reveal the interior components.

FIG. 6 is a perspective view of the case with the cover removed and portions broken away to reveal interior components.

FIG. 7 is a perspective view of the stud plate.

FIG. 8 is an elevation view of the post.

FIG. 9 is a perspective view of the clevis.

FIG. 10 is a view of the fish tape of the present invention with a portion of the wrap cut away to reveal the core.

FIG. 11 is a cross section of the armor wrap wire used in the fish tape of FIG. 10.

### DETAILED DESCRIPTION OF THE INVENTION

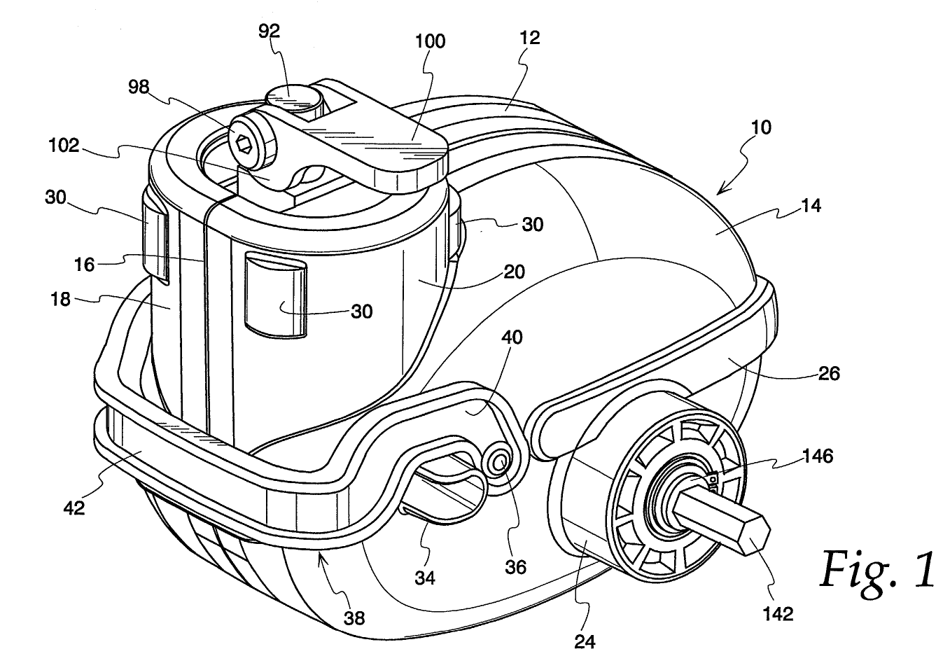

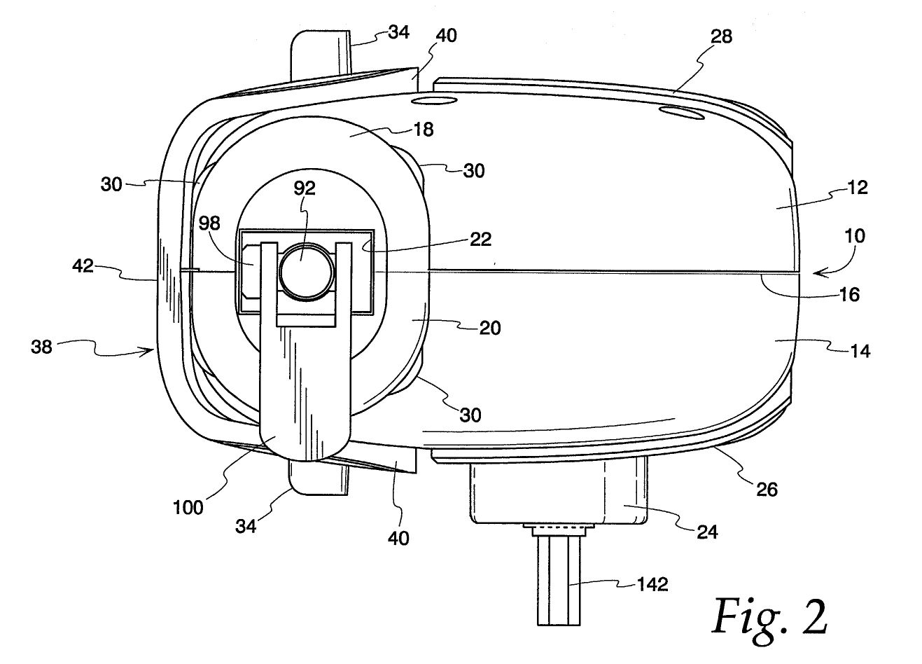

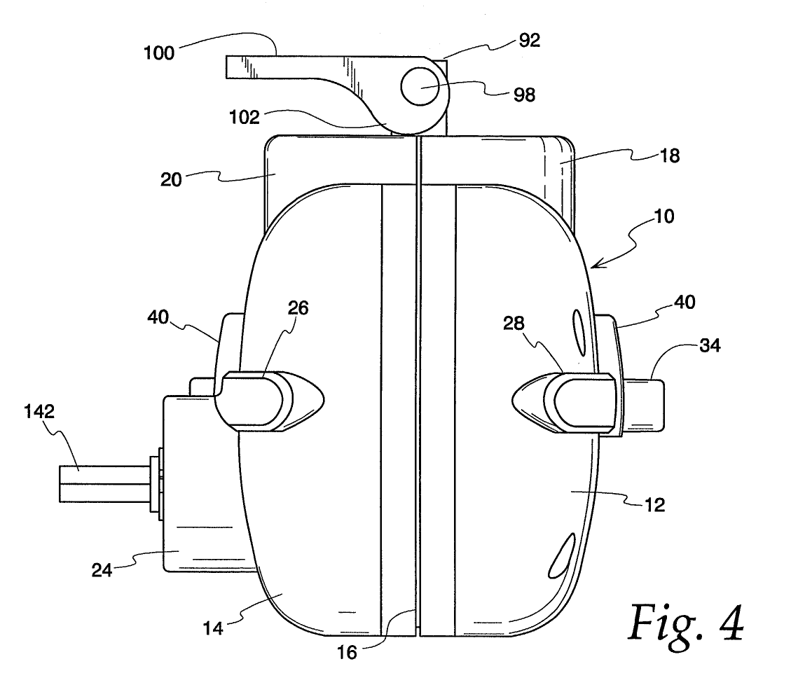

FIGS. 1-4 illustrate the fish tape driver 10 of the present invention. The driver has a two-piece housing including a case 12 and a front cover 14. The case and cover are joined at a separation line 16. The case 12 has an upstanding, U-shaped enclosure 18 while the cover 14 has a similar enclosure 20. Together the enclosures define a pressure roller chamber with an opening 22 (FIG. 2) in the top. There is a circular boss 24 extending from the face of the cover 12. Just above the boss 24 there is a band 26 where the cover 14 has increased thickness for reinforcement. A similar band 28 is formed on the case 12. Embossments 30 are located on the exterior of the enclosures 18 and 20. These are intended to provide wear pads. The housing is preferably molded of suitable plastic material, such as glass-filled ABS or glass-filled nylon. Alternately, the housing could be die cast metal.

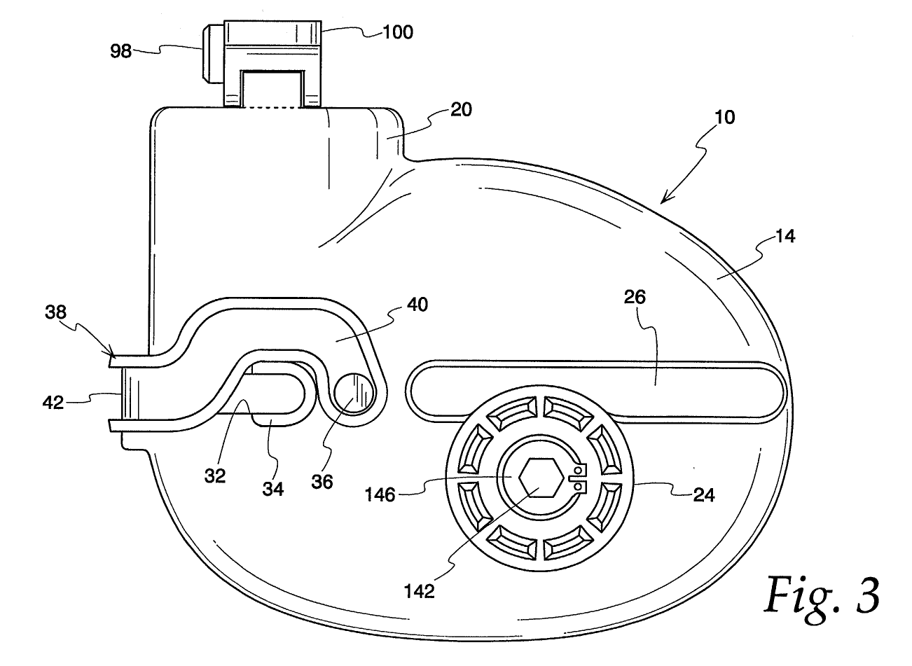

The left side of the housing, as seen in FIG. 3, has a slot 32 formed therein. The slot provides access to the interior of the driver housing. The slot is bounded by C-shaped extensions 34 extending from both the case 12 and cover 14. Adjacent the extensions 34 are pivot heads 36. The pivot heads mount a retainer 38. The retainer has two arms 40 joining a bar 42. The arms have eyelets that fit over the pivot heads to mount the retainer on the housing. The arms 40 bend around the extensions 34 so the bar 42 is normally aligned with the slot 32. The retainer pivots upwardly from the position shown in FIG. 1 to open the slot 32 for insertion of a fish tape. Gravity will normally cause the retainer to fall to the closed position shown, with the C-shaped extensions 34 limiting movement of the arms 40. Together the extensions 34 and the retainer 38 help hold a fish tape in the driver by preventing it from canting about a vertical axis.

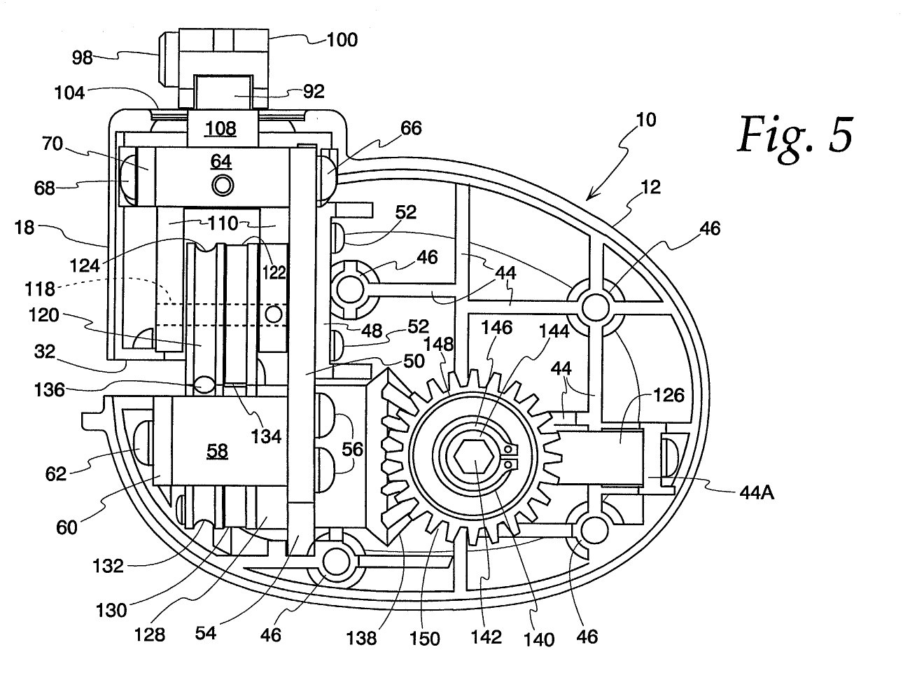

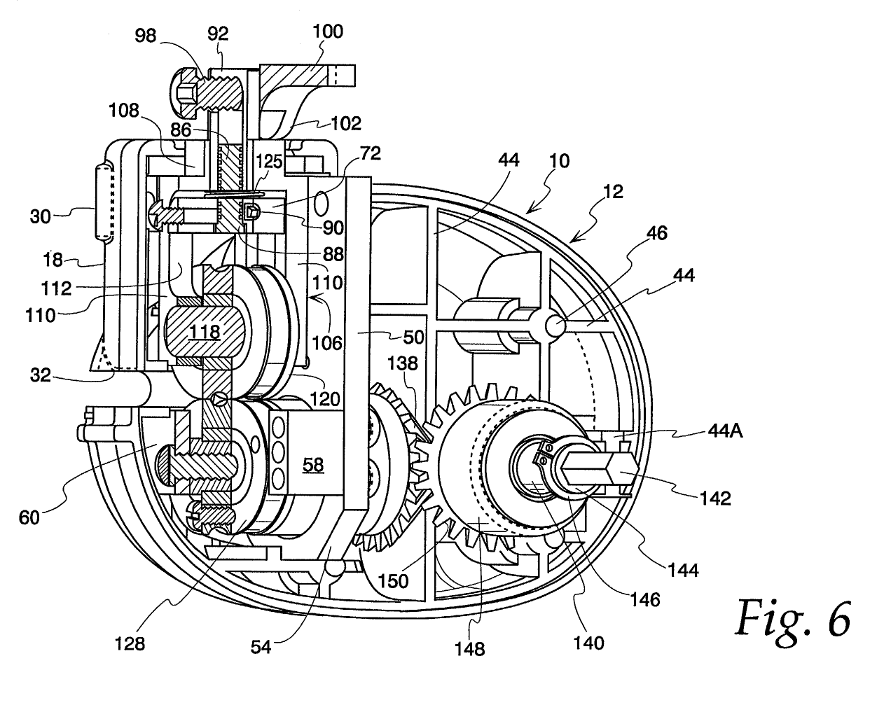

The interior of the driver 10 is shown in FIGS. 5 and 6. These views show the case 12 with the cover removed. The case includes a plurality of reinforcing webs 44. At the intersection of four of these webs are sockets 46 that receive screws (not shown). The screws join mating sockets in the cover to hold the two pieces of the housing together. The case also has a wall 48 to which a metal mounting plate 50 is attached by screws 52. The bottom of the plate 50 is beveled at 54 to clear the curving sides of cover and case. The lower portion of the mounting plate has an opening 55 (FIG. 6) which allows passage of a drive roller as will be explained below. Screws 56 attach front and rear lower bars to the mounting plate 50. Only the front lower bar is visible at 58. The rear lower bar is behind the drive roller and not visible in FIGS. 5 and 6. The front and rear lower bars are connected by a lower strap 60, which is connected to the bars by screws 62. The lower bars and strap and mounting plate form a box frame around the drive roller. A similar box frame is formed at the top of the mounting plate 50 by front and rear upper bars, the front bar showing at 64 in FIG. 5. Screws 66 attach the bars to the mounting plate. Screws 68 attach an upper strap 70 to the front and rear upper bars. Between the upper bars there is a cross-shaped stud plate 72 screwed to the mounting plate 50 and strap 70 to complete the upper box frame.

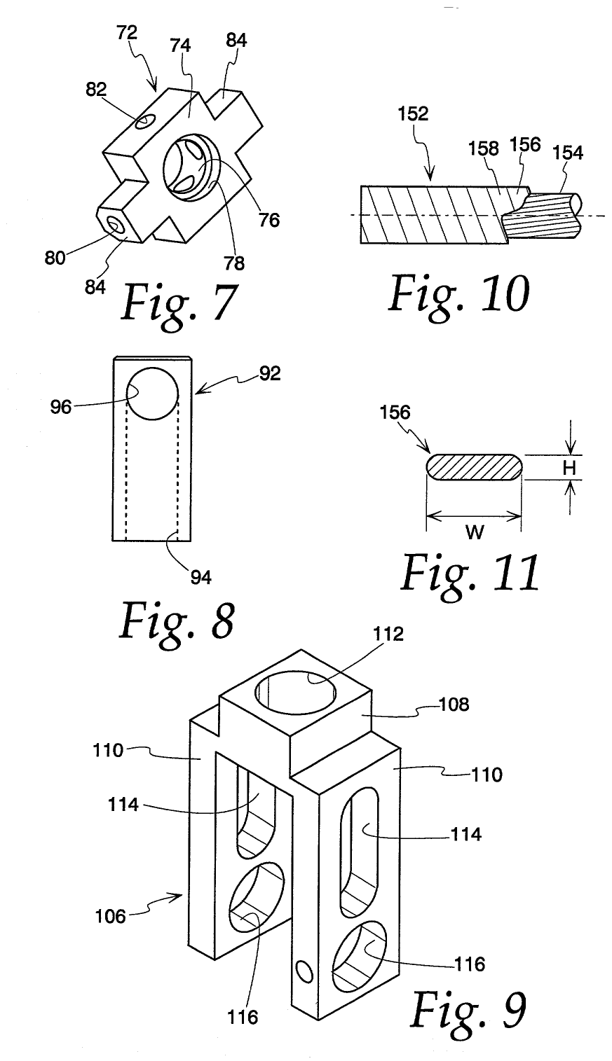

Details of the stud plate 72 are shown in FIG. 7. It has a body portion 74 with a central bore 76 through the body portion. A counterbore 78 extends into the body from one face thereof. A threaded set screw opening 82 extends through the body to the central bore 76. A pair of arms 84 extend from the body and have threaded bores 80 which receive the screws from the mounting plate 50 and strap 70. The stud plate 72 mounts a stud 86. The stud has a threaded shank that extends upwardly through the central bore 76 and a head 88 that fits in the counterbore 78. A set screw 90 threaded in opening 82 engages the stud shank and fixes the stud 86 to the stud plate 72.

The stud 86 supports a post 92, details of which are shown in FIG. 8. The post is generally cylindrical with a threaded axial bore 94 and a transverse bore 96 near its upper end. The post 92 is adjustably mounted on the stud by means of the engaging threads in the bore 94 and on the shank of the stud 86. The transverse bore 96 of the post carries a pivot shaft 98 on which a locking lever 100 pivots. The locking lever 100 includes a cam 102. A washer may be placed underneath the cam to serve as a wear pad. The locking lever 100 and cam 102 provide a quick locking capability for holding the pressure roller in a desired position, as will be explained below

The upper box frame mounts a clevis 106 for vertical movement therein. Details of the clevis 86 are shown in FIG. 9. The clevis has a block 108 connected to two depending forks 110. There is an opening 112 in the block 108. Each fork 110 has an elongated slot 114 through which the arms 84 of the stud plate extend. This allows the clevis to move up and down. The forks 110 also have apertures 116 which receive an idler shaft, shown at 118 in FIG. 6, on which a pressure roller 120 is mounted. The pressure roller has bearings which allow it to rotate on the shaft 118 carried by the clevis 106. The pressure roller has two grooves formed in its surface. There is a flat or rectangular groove 122 and a curved or concave groove 124. Returning to FIGS. 5 and 6, it can be seen that the clevis 106 is urged upwardly by a compression spring 125 which rests on the top of the stud plate body 74, surrounding the stud 86 and engaging the underside of the clevis block 108. The upward movement of the clevis is limited by the cam 102.

A main shaft 126 is fixedly mounted in the case 12 and extends almost the fill width of the case. At the right end, as seen in FIG. 5, the main shaft is fastened to a web 44A of the case. At the left end the main shaft is fastened to the lower strap 60. As can be seen the main shaft 126 extends through the opening 55 in the mounting plate 50 and through the lower box frame. Mounted for rotation on the main shaft is a drive roller 128. Needle bearings may be used to mount the drive roller. The left end of the drive roller has two grooves similar to those on the pressure roller 120. There is a rectangular groove 130 and a curved groove 132. These are aligned with the similarly shaped grooves 122 and 124 of the pressure roller. Together the grooves define a pair of throats 134 and 136. Each throat is tangent to the rollers 120 and 128 at the point where the rollers are closest to one another. Thus, in the illustrated embodiment, the throat extends perpendicular to the plane of the drawing of FIG. 5, i.e., in and out of the paper. The throats each defme an axis that is perpendicular to the main shaft 126 and the idler shaft 118. Each throat is adapted to receive a fish tape of particular shape therein along the throat axis.

The drive roller 128 further includes at its right end, as seen in FIG. 5, a first right angle gear 138. In the illustrated embodiment this is a bevel gear formed integrally with the drive roller. It will be understood that a separate gear in driving engagement with the drive roller could be used or other forms such as a worm and gear could be used.

A drive shaft 140 is mounted for rotation in the boss 24 of the cover 14. The drive shaft is shown in FIG. 5 although the cover is removed in this view. The drive shaft 140 is parallel to the throat axis. The drive shaft extends to a proximal end 142 outside of the cover of the housing, as seen in FIGS. 1-4. The proximal end 142 has a hexagonal cross section which is engageable with the chuck of a hand drill or other power source. A hand drill is preferred because almost all electricians have such a tool. The proximal end of the shaft may include a flange 144 and split washer 146 for retaining the drive shaft 140 in the boss 24. A second right angle gear 148 is fixedly mounted on the drive shaft 140 for rotation with the drive shaft. The second right angle gear is a bevel gear having teeth 150 meshing with those of the first right angle gear. Thus, the second right angle gear transfers rotation of the hand drill to the drive roller 128.

The use, operation and function of the fish tape driver are as follows. Some electricians using a steel band type fish tape prefer to uncoil the entire fish tape and lay the entire length on the floor prior to fishing it through a conduit. Others will leave it in its case and feed it out as needed. Other types of fish tape may also be left in the case and fed out of the case as it is fished through the conduit. In either case, a fish tape is readied for use with the driver 10 and the proximal end 142 of drive shaft 140 is locked in the hand drill chuck. Locking lever 100 is pivoted to a generally vertical position to release the cam 102. If need be the lever 100 is rotated to rotate the post 92, moving the post upwardly on the stud 86. This allows the clevis to move upwardly under the force of spring 125 and thereby open the throats 134, 136. The retainer 38 is lifted up to expose the slot 32 in the housing. A portion of the fish tape is then moved perpendicular to its length into the slot and into one of the throats 134, 136. The throat used depends on the cross sectional shape of the fish tape. For round tapes the throat 136 with the curved grooves 124 and 132 is used. For rectangular fish tape the throat 134 with the flat grooves 122 and 130 is used. Thus, the driver accommodates any type of fish tape without having to change the rollers. It will also be noted that the slot allows the fish tape to be inserted into the driver without having to thread the leader through the driver. That is, the fish tape will have a connector on its end for attachment of the wires. The connector has a much larger cross section that the rest of the fish tape. That connector does not have to fit through the driver because the tape will be inserted into the driver at a point on the tape behind the connector.

Once the fish tape is in the throat the retainer 38 is allowed to drop down over the slot opening to help hold the tape in place. Then the clevis 106, and thus the pressure roller 120, is pushed down onto the fish tape. The post 92 may also be rotated down onto the stud 86 to adjust the length of the stud/post combination. Once the proper length is obtained and there is adequate pressure on the tape, the locking lever 100 is pivoted to cause the cam 102 to engage the top surface of the clevis block 108 (through the washer if present) and thus lock the clevis 106 in position. The driver and hand drill combination is then carried to the conduit and the fish tape leader is then threaded into the conduit. The back side of the housing is pressed up against the conduit and the drill is activated to drive the drive shaft 140, second right angle gear 148, first right angle gear 138 and drive roller 128. The pressure on the fish tape from the pressure roller 120 creates sufficient friction to result in the fish tape being driven into the conduit. When the leader comes out of the other end of the conduit the hand drill is shut off and the wires are attached to the leader. The drill direction is reversed and the fish tape is pulled back through the conduit by activating the drill. When the wires emerge the drill is shut off. If no further use is anticipated the tape can be removed by releasing the locking lever cam 102. The spring 125 will lift the pressure roller 120 somewhat. If further clearance is needed to open the throat and allow removal of the tape, unscrewing the post 92 will allow the pressure roller to rise some more. With the retainer 38 lifted the fish tape can then be removed out the slot 32 of the driver.

It will be noted that the right angle drive members allow a compact arrangement with the hand drill axis parallel to the fish tape. This permits manipulation of the drill and driver combination with a single hand. The other hand remains free for holding a ladder or the like. Also, the retainer arm allows the access slot to open and close. The arms of the retainer close around the fish tape at both the front and back sides of the housing. This plus the C-shaped extensions 34 prevents the fish tape from canting or wobbling in the throat of the rollers.

The improved fish tape 152 of the present invention is shown in FIG. 10. The tape has a wire rope core or center 154. In one embodiment this may be a .072 inch diameter 1×13 galvanized cable. The core is covered by a wrap or sheath made of two ribbons 156, 158 of armor wrap wire. This wire has a generally rectangular cross section as shown in FIG. 11. In the described embodiment the wire wrap has a width W of about .100 inches and a height H of about .015 inches. The corners have a radius as shown. The armor wrap wire may be a stainless steel, and the wire rope core may be formed of carbon steel or stainless steel. Use of stainless steel in both the wire rope and the flat wrap is preferred for its corrosion resistance. The wrap is applied with no gap between the convolutions. This gapless construction aids in preventing snagging as the fish tape is fished through a conduit.

In an alternate embodiment the fish tape may be composed of .125 diameter armor core cable. This embodiment may rely on .093 diameter 1×l9 galvanized cable. Around the cable is wrapped flat, stainless steel wire. Each of the described embodiments forms a round, stiff, yet somewhat flexible line. This line has the ability to be pushed and pulled through conduit very effectively, bending in any direction needed, as many times as needed, yet providing compressive and tensile strength and stiffness along its axial direction. The circular or cylindrical wrap orientation allows obstructions to slide by. The circular wrap of the ribbon or wrap component around the fish tape also gives the ability to easily push through even more than the four ninety-degree turns permitted in 100 feet of conduit.

The fish tape of FIGS. 10 and 11 is tremendously strong and can withstand tensile forces in excess of 1800 pounds. It is round and not flat. On the outward end of the tape is an eyelet that is used to attach cables, wires etc. to be pulled back through conduit. At 1800 pounds of tension, a stainless steel eyelet on the end failed, not the tape itself. The surface of the armoring sheath is also very hard. When pliers were used to grip the line, no scoring or damage was observed to occur on the stainless steel wrap. Neither the sheathing, nor the wire rope making up the fish tape were observed to rust, even when used in wet, muddy conditions, or when stored in a closed case. Flexibility is not changed due to temperature differences and other weather conditions that might greatly affect the performance of a conventional fish tape.

Electricians find that the flexible tape of the present invention is sufficiently stiff to move through a conduit under compressive forces. However, the lateral rigidity is substantially less. For example, the line will fall to the ground immediately upon exit from a conduit, thus falling away from the panel to curl up on the floor. By contrast, conventional steel fish tapes often spring uncontrollably upward, due to their great lateral stiffness, striking the panel and potentially causing electrical shorts or other obstructions. The lack of lateral rigidity of the present invention permits it to be used with a case or reel of the type shown in U.S. Pat. No. 5,423,516, the disclosure of which is incorporated herein by reference. The fish tape does not have the tendency to spring out so it can be coiled easily on the external circumference of a drum, without the need for the control springs used in the first embodiment of U.S. Pat. No. 5,423,516.

From the above discussion, it will be appreciated that the present invention provides a semi-stiff fish tape for deploying into conduits and for drawing wires back through the conduits. The fish tape is easily deployed and retrieved by a user cranking a portion of the case or with the driver described above.

While a preferred form of the invention has been shown and described, it will be realized that alterations and modifications may be made thereto without departing from the scope of the following claims. For example, the case 12 may have a conically shaped nose portion at the slot 32 to help align the housing with the opening of a conduit.

We claim:

1. A fish tape driver, comprising:
a housing;
a main shaft and an idler shaft mounted parallel to one another in the housing;
a drive roller mounted for rotation on the main shaft and a pressure roller mounted for rotation on the idler shaft, the rollers being aligned with one another to define a throat along the tangents to the rollers that are parallel and closest to one another, the throat having a throat axis perpendicular to said main and idler shafts, the throat being adapted to receive a fish tape therein along the throat axis, the rollers being engageable with a fish tape placed in the throat to drive the fish tape;
a first right angle gear in driving engagement with one of the main shaft and drive roller;
a drive shaft mounted for rotation in the housing parallel to the throat axis and extending to a proximal end exterior of the housing, the proximal end being engageable with a hand drill; and
a second right angle gear meshing with the first right angle gear and mounted for rotation with the drive shaft.

2. The fish tape driver of claim 1 further characterized in that the housing has a slot providing access to the throat and further comprising a retainer pivotably mounted on the housing for opening and closing said slot.

3. The fish tape driver of claim 2 wherein the housing and the retainer cooperate to prevent a fish tape that has been loaded in the driver from canting in the throat.

4. A fish tape driver, comprising:
a housing defining a slot therein;
a main shaft and an idler shaft mounted parallel to one another in the housing;
a drive roller mounted for rotation on the main shaft and a pressure roller mounted for rotation on the idler shaft, the rollers being aligned with one another to define a throat along the tangents to the rollers that are parallel and closest to one another, the throat having a throat axis perpendicular to said main and idler shafts, the throat being adapted to communicate with the slot to receive a fish tape therein along the throat axis, the rollers being engageable with a fish tape placed in the throat to drive the fish tape;
a drive shaft mounted for rotation in the housing and extending to a proximal end exterior of the housing, the proximal end being engageable with a hand drill;
a drive train mounted in the housing and engageable with the drive shaft and the drive roller to transfer rotation of the drive shaft to the drive roller; and
a retainer pivotably mounted on the housing for opening and closing said slot.

5. The fish tape driver of claim 5 wherein the housing and the retainer cooperate to prevent a fish tape that has been loaded in the driver from canting in the throat.
